(19) United States
(12) Patent Application Publication
(10) Pub. No.: US 2023/0065960 A1
(43) Pub. Date: Mar. 2, 2023

(54) METHOD AND SYSTEM FOR PROCESSING HIGH-GRAVITY BEER INTO SPIRITS

(71) Applicant: COORS BREWING COMPANY, Wilwaukee, WI (US)

(72) Inventors: Frederik HAVEL, Beaconsfield (CA); Lee Arthur GRIFFITHS, Staffordshire (CA)

(21) Appl. No.: 17/792,934

(22) PCT Filed: Dec. 31, 2020
(86) PCT No.: PCT/US20/67617

§ 371 Date: Jul. 14, 2022

Related U.S. Application Data
(60) Provisional application No. 62/962,358, filed on Jan. 17, 2020.

(51) Int. Cl. C12G 3/08; C12C 11/11; C12H 1/07; C12H 1/22

(52) U.S. Cl. CPC C12G 3/08; C12C 11/11; C12H 1/063; C12H 1/22

(57) ABSTRACT

Methods and systems are provided that process beer into an oxygen-stable long shelf life spirit. The process includes introducing oxygen into the beer and heating the beer to a temperature within a predetermined temperature range and allowing the beer to age at the predetermined temperature for a number of days. During this aging process, the beer transforms into an oxidized beer spirit. The beer spirit is cooled to room temperature and is then chilled for a period of time to separate unwanted precipitate and byproducts from the beer spirit. After the beer spirit is chilled, the beer spirit is forced through at least one filter to remove precipitate and provide a clear and filtered spirit having a complex taste and aroma profile.

### CROSS REFERENCE TO RELATED APPLICATION

The present application claims the benefit of and priority, under 35 U.S.C. § 119(e), to U.S. Provisional Application Ser. No. 62/962,328, filed Jan. 17, 2020, entitled “Method and System for Processing High-Gravity Beer into Spirits,” the entire disclosure of which is hereby incorporated herein by reference, in its entirety, for all that it teaches and for all purposes.

### BACKGROUND

The present disclosure is directed to the treatment of beer and, in particular, toward a temperature-controlled aging treatment process that converts beer into spirits.

It is the goal of every brewer to maintain high quality flavor and consistency between batches. In the last 40 years, brewers have learned that controlling the exposure to oxygen during various stages of brewing and/or storage is critical in avoiding damage to the flavor, aroma, and clarity of the beer. Specifically, exposure to oxygen will cause an oxidation reaction in many of the key components of the beer and negatively alter the taste and thus shorten the shelf life.

As the temperature of a stored beer increases, and/or as the time storing the beer increases, so does the staling of the beer. Heat, time, and oxygen are the principal promoters of stale beer flavors. These stale flavors have been associated with imparting a cardboard, paper, bready, and/or caramel taste to the beer. Heat, time, and oxygen will also promote the formation of haze or, inversely, result in a reduction of beer clarity. This increase in a beer's turbidity is also seen as a loss of shelf life in most beer styles.

In contrast to beer, where oxidation is considered harmful to flavor and shelf life, some alcoholic beverages like rancio wine, port, sherry, whiskey, cognac, brandy, and rum, for example, embrace oxidation to obtain a complex flavor and aroma profile. Unlike beer, these purposely-oxidized alcoholic beverages provide the ability to repeatedly open and close a bottle over time and consume the beverage over a period of months or years without the fear of ruining the quality of the beverage due to oxidation.

### BRIEF SUMMARY

In certain embodiments, the present disclosure relates to a method and system that provides a spirit made from beer by embracing oxidation during aging of the beer. In some embodiments, a method for converting beer into spirits is provided comprising: introducing a beer into an aging tank; heating the beer inside the aging tank to a controlled temperature, wherein the controlled temperature is in a range of 45° C. to 50° C.; maintaining the controlled temperature of the beer inside the aging tank for an aging period, introducing oxygen into the beer while inside the aging tank, wherein during the aging period the beer transforms into a spirit; holding the spirit at a chill temperature in a range of −2° C. to −6° C. for a chill period; and pumping the spirit through a filtration system.

In some embodiments, a system for transforming beer into spirits is provided, comprising: a feed stream providing a beer having an alcohol by volume in a range of 20% to 54%; a heated tank set at an elevated temperature within a range of 45° C. to 50° C., wherein the heated tank holds the beer at the elevated temperature received from the feed stream for a predetermined aging time period; an oxygen introduction system that introduces oxygen into the beer while held inside the heated tank, wherein the oxygen is introduced into the beer such that the beer comprises a dissolved oxygen concentration in a range of 300 ppb to 2,000 ppb, and wherein during the predetermined aging time period the beer transforms into a spirit; a chilled tank set at a temperature within a range of −2° C. to −6° C., wherein the chilled tank holds the spirit received from the heated tank for a predetermined chill time period; a filtration system comprising a series of filter elements arranged in a fluid flow path; a pump that conveys the spirit from the chilled tank after expiration of the predetermined chill time period through the filtration system via the fluid flow path; and a collection tank that stores the spirit pumped through the filtration system.

In some embodiments, a method is provided comprising: receiving a beer having an alcohol by volume of at least 24%; decanting the beer into an intermediate bulk container; diluting the beer to an alcohol by volume of 21% using a deaerated liquid; aging the diluted beer in a holding tank at a temperature of 45° C. to 50° C. for an aging period between 7 and 21 days; introducing oxygen into the beer while in the holding tank, wherein the oxygen is introduced into the beer such that the beer comprises a dissolved oxygen concentration in a range of 300 ppb to 2,000 ppb, and wherein the introduction of the oxygen and the aging together transforms the beer into a spirit; cooling the spirit to a temperature below 45° C.; chilling the spirit to a subzero temperature of −2° C. to −6° C. for a chill period between 24 and 72 hours; filtering the chilled spirit through a filter media having a filtration size between 0.5 and 5 microns; conveying the filtered spirit to a storage container; and adding flavor extracts to the filtered spirit.

### BRIEF DESCRIPTION OF THE DRAWINGS

FIG. 1 is a flow diagram of a method for processing beer into spirits in accordance with embodiments of the present disclosure;

FIG. 2 is a block diagram of a beer spirit processing system in accordance with embodiments of the present disclosure; and

FIG. 3 is a block diagram depicting an illustrative controller in accordance with embodiments of the present disclosure.

### DETAILED DESCRIPTION

Although the oxidation of beer has been avoided in the past, embodiments of the present disclosure describe a process where oxidation is embraced, and even encouraged or induced, to produce a spirit from the oxidized beer having a complex flavor and aroma profile. The oxidation may be induced by exposing the beer to oxygen (e.g., O₂) and/or one or more oxygenated compounds. This exposure may include, but is in no way limited to, passive contact between the beer and air in the environment (e.g., via a tank having a large head space that is exposed to an oxygenated atmosphere, etc.), injecting pressurized oxygen into the beer, infusing oxygen into the beer (e.g., via a bubbler, air diffusion aerator, or other aeration system, etc.), adding oxygenated compounds (e.g., ozone, air, peroxide, hydrogen peroxide, plant-based byproduct, etc.) into the beer, and/or the like.

Embodiments of the present disclosure will be described in connection with a system and method for processing beer into spirits. The term “beer” and variations thereof, as used herein, may refer to a beverage brewed from any type of grain (e.g., lagers, ales, porters, bocks, stouts, wheat beers, etc.), or other yeast-fermented malt beverage, of any alcohol by volume (ABV) percentage including non-alcoholic and alcoholic percentages such as a beer having an ABV of approximately 5% to 14.9% (e.g., a high-gravity beer), a beer having an ABV of approximately 15% to 23.9% (e.g., a very-high gravity beer), and/or a beer having an ABV of approximately 24% to 54%, or more (e.g., an ultra-high gravity beer), and/or the like. It should be appreciated that the methods and systems described herein may be applied to beer of any ABV including, but in no way limited to a beer having an ABV greater than 0.05%, etc.

In some embodiments, the beer may be received at 5% ABV or above. In one embodiment, the beer may be received at 24% ABV or higher. The beer may be dewatered to reach the ABV of 24% or more. In some embodiments, the dewatering may include a reverse osmosis (RO), forward osmosis (FO), and/or a combination (e.g., RO/FO, etc.) dewatering process. As can be appreciated, beer having an ABV of 24% or higher may be flammable. In some embodiments, the beer may be diluted to an ABV less than 24%. For instance, the beer may be diluted to 15% ABV, 18% ABV, 20% ABV, 21% ABV, and/or some other ABV value within a range of these values and/or any value less than 24% ABV. In one embodiment, the beer may be diluted to about 21% ABV by adding deaerated water to the beer, or any other water or liquid that is capable of adjusting the ABV of the beer to a predetermined ABV amount. In one embodiment, the beer may be diluted using a deaerated liquor (DAL). In any event, the beer may be diluted to the predetermined ABV amount (e.g., of approximately 21% ABV, or lower, etc.) based on safe handling requirements, flammability concerns, and/or final ABV considerations.

Next, the beer may be aged at an elevated temperature for an aging time period. The aging time period may be any time greater than three days, and in one embodiment, may be time period of about seven to twenty-one days. During this aging time period, oxygen may be introduced into the beer via one or more techniques. For instance, the oxygen may be introduced via aeration, injection, infusion, and/or other contact made between the beer and oxygen. In some cases, the oxygen may be introduced as part of an oxygenated compound that is mixed with the beer. The introduction of oxygen increases dissolved oxygen concentration in the beer and induces oxidation of the beer while it is aging over time. This introduction of oxygen may be continuous or periodic during the aging time period. Further, the introduction of oxygen into the beer may be controlled (e.g., based on a feedback loop, etc.) to maintain the beer within an acceptable oxygen concentration range (e.g., below saturation). For instance, the dissolved oxygen concentrations may be controlled to any concentration value between, and including, 8 ppm and 32 ppm. In one embodiment, the dissolved oxygen concentrations may be in the range of 300 ppb to 2,000 ppb. The elevated temperature may be set to approximately 45° C. to 50° C., give or take several degrees. In one embodiment, the elevated temperature may be set to value within a temperature range of approximately 40° C. to 60° C. In some embodiments, the beer may be maintained at the elevated temperature for the entire aging time period. The aging at the elevated temperature promotes oxidation in the beer. Specifically, the elevated temperature may drive oxidation of various polyphenol/protein complexes and colloidal stability in the beer. Additionally or alternatively, this aging process may create Strecker aldehydes, Maillard compounds, furanones, and/or other oxygen-generated flavor compounds in the beer.

After the aging time period is completed, the beer may be allowed to cool to room temperature (e.g., to a temperature from about 20° C. to 25° C., etc.), or some other predetermined temperature that is lower than the elevated temperature (e.g., of 45° C. to 50° C., or some other value in the range of 40° C. to 60° C., etc.). While this cooling is not time critical, the beer may be allowed to cook back naturally if necessary.

Once cooled to room temperature, the beer may then be chilled to a subzero (e.g., measured in degrees Celsius) temperature. In one embodiment, the subzero temperature may be set to a value between, and/or including, −1° C. to −10° C. In some embodiments, the beer may be chilled to a temperature between −2° C. to −6° C. In some embodiments, the beer may be held within, or about, this temperature range for a chill time period. In one embodiment, this chill time period may be an amount of time greater than 8 hours. In some embodiments, the chill time period may be approximately 24 to 72 hours in duration. Among other things, this chilling for the chill time period forces precipitation of the polyphenol/protein complexes from the beer (e.g., chill haze).

The complexes may then be filtered off, leaving a flavorful spirit produced from beer, which may be enhanced with additional flavoring compounds, extracts, etc. In some embodiments, the spirit may be bottled and packaged as a shelf-stable (e.g., oxygen-stable) drink such as spirit, aperitif, or digestif.

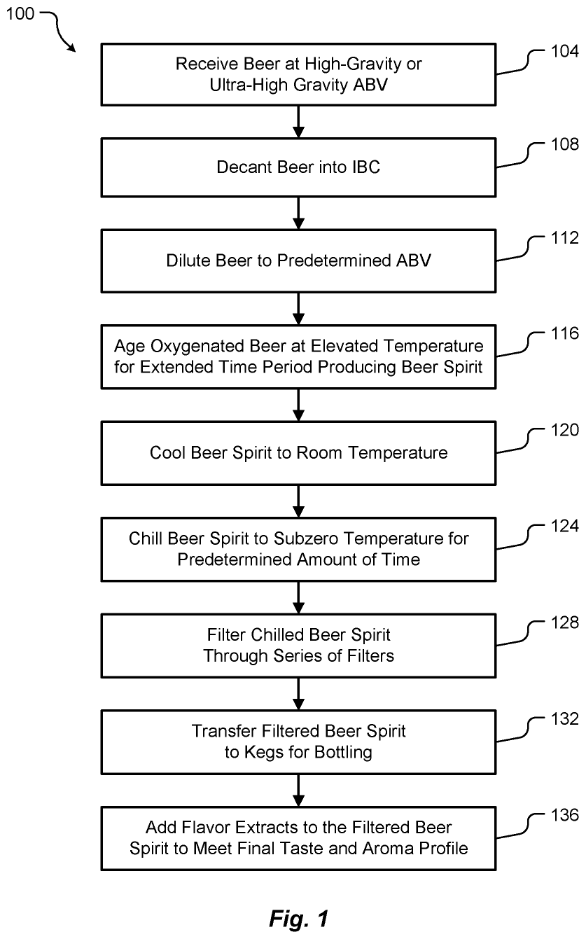

Referring to FIG. 1, a flow diagram of a method 100 for processing beer into spirits is shown in accordance with embodiments of the present disclosure. In one embodiment, the method 100 begins by receiving beer at approximately 20% ABV or higher (step 104). The beer may correspond to a beer that has been dewatered, or dehydrated, leaving a higher ABV in the beer. In some embodiments, the beer may be provided via one or more fluid lines, pipes, tanks, or the like. For instance, the beer may be pumped, or otherwise conveyed, along a fluid line from a manufacturing or brewing source. In one embodiment, the beer may be received in discrete bags (e.g., 20 L bags, etc.). Packaging the beer in discrete bags may allow the beer to be safely handled, from a flammability and/or fluid control perspective. In some embodiments, the beer may be continuously provided via a pipeline, directly from an RO, FO, or RO/FO concentration buffer tank, unit, or pipe.

In some embodiments, the method 100 continues by decanting the beer from the 20 L bags into an intermediate bulk container (IBC), or tote (step 108). In one embodiment, the IBC may correspond to a 1,000 L tank with metal surrounding cage, or the like. The beer may be decanted through a fluid line into the IBC. The fluid line may be affixed with a sensor to ensure and/or maintain a proper fluid flow rate.

In one embodiment, the beer may be received at 24% ABV, or higher. As described above, beer received at 24% ABV or more may be flammable, and any number of precautions and techniques may be implemented to prevent ignition of the beer. In this example, the method 100 may continue by diluting the 24% ABV beer to a 21% ABV beer using, for example, deaerated water or DAL (step 112). In some embodiments, the 24% ABV beer may be diluted using ordinary water, or with any other dilution liquid (e.g., DAL, etc.) acceptable for consumption after processing. Among other things, this dilution adjusts the overall ABV of the beer from 24% (or more) to approximately 21% and, as such, lowers the flammability of the beer.

Next, the method 100 proceeds by aging the beer at an elevated temperature for a predetermined period of time (step 116). Specifically, the beer may be heated using a heating element (e.g., heated tank, etc.) to between 45° C. to 50° C., and held at that elevated temperature for anywhere between 7 days and 21 days (e.g., aged). During this predetermined period of time, oxygen may be introduced into the beer. The oxygen may be introduced via aeration, injection, infusion, and/or other contact made between the beer and oxygen. In some cases, the oxygen may be introduced as part of an oxygenated compound that is mixed with the beer. The introduction of oxygen increases dissolved oxygen concentrations in the beer and induces oxidation of the beer while it is aging over time. This introduction of oxygen may be continuous or periodic during the aging time period. Further, the introduction of oxygen into the beer may be controlled to maintain the beer within an acceptable oxygen concentration range (e.g., below saturation). Control of the dissolved oxygen concentrations may include measuring the dissolved oxygen concentration levels, for example, via a dissolved oxygen sensor that is in contact with the beer. The dissolved oxygen sensor may be in communication with a controller that is capable of adjusting the rate at which oxygen is introduced into the beer. Based on the measured dissolved oxygen concentration, the controller may decrease (e.g., when the measured dissolved oxygen concentration raises above a threshold value, etc.), increase (e.g., when the measured dissolved oxygen concentration falls below a threshold value, etc.), and/or cease (e.g., when the measured dissolved oxygen concentration is outside of an acceptable concentration range) the introduction of oxygen into the beer. This rate may be controlled periodically or continuously while the beer is aging. In one embodiment, the beer may be maintained and/or controlled to have dissolved oxygen concentrations in the range of 300 ppb to 2,000 ppb in a specific volume of beer. This aging process (e.g., maintaining the oxygenated beer at the elevated temperature over time) drives oxidation of polyphenols and so complexation of the polyphenols with proteins into solids which can be removed by filtration resulting in greatly improved colloidal stability. The aging process also drives the formation of Strecker aldehydes, Maillard compounds, furanones, and/or other flavor compounds. At this point, the oxidized aged beer may be referred to as a beer spirit.

After the aging process, the method 100 proceeds by allowing the beer spirit to cool to room temperature (step 120). In some embodiments, step 120 may include turning off the heat produced by the heating element and allowing the beer spirit to cool from the elevated temperature (e.g., of about 45° C. to 50° C.) to a room temperature (e.g., of about 20° C. to 25° C., etc.) over time. This removal of the heat produced by the heating element and the gradual cooling over time may be referred to as a natural cooling process. In some embodiments, the beer spirit may be cooled from the elevated temperature by actively cooling the beer spirit using a refrigerated element (e.g., refrigeration coils, cooled tank, etc.).

Next, the method 100 continues by chilling the beer spirit to a subzero chill temperature in a temperature range, for example, of about −2° C. to −6° C. and maintaining the beer spirit at the chill temperature for a chill period of about 24 hours to 72 hours, or more (step 124). The beer spirit may be chilled using, for example, a cooling system such as a refrigeration unit, chiller, chilled holding tank, etc., and/or combinations thereof. In one embodiment, the cooling system may comprise a tank or fluid line that is temperature controlled by a chiller. The chiller may comprise a glycol, or other, cooled system having one or more coolant lines that wrap around a portion of a chilled holding tank containing the beer spirit. In one embodiment, the chiller may comprise a plate and frame heat exchanger. For instance, the beer spirit may flow on one side of the heat exchanger, while a coolant (e.g., glycol, etc.) may flow on the other side of the heat exchanger thereby cooling the beer spirit to the chill temperature. Holding, or otherwise maintaining, the beer spirit at the chill temperature causes precipitation of the polyphenol/protein complexes that formed during the aging process. In some cases, “holding” the beer spirit in a chilled holding tank may include slowly pumping, moving, or conveying the beer spirit along one or more fluid lines inside the chilled holding tank. Stated another way, the beer spirit does not need to remain in a static, or unmoving, condition in the chilled holding tank for the chill period.

Once sufficiently cooled and held for the chill period, the beer spirit at the chill temperature (e.g., chilled beer spirit) may be passed onto a filtration system (step 128). In one embodiment, the chilled beer spirit may be pumped through one or more fluid lines via a pump. The filtration system may include one or more filters arranged to filter solids, ingredients, and/or compounds from the chilled beer spirit. The filters may include a pre-filter having a first size of filter media and a fine-filter having a second size of filter media. In some embodiments, the first size of filter media may be coarser than the second size of filter media. For instance, the pre-filter may include one or more cellulose and/or polypropylene membranes having a 1.0 micron to 5.0 micron filtration size. The fine-filter may include a ceramic and/or polysulfone membrane, a polypropylene filter, and/or a diatomaceous earth depth filter. The fine-filter may have a filtration size set smaller, or finer, than the pre-filter (e.g., 0.5 microns, less than 1.0 microns, etc.). In one embodiment, the beer spirit may be filtered through a single filter (e.g., frame and plate filter, etc.) having a filtration size set to approximately 1.0 micron. The chilled beer spirit may be pumped through the filters and into a storage tank, where the filtered beer spirit may be held prior to packaging. In any event, the filtration step filters the complexes out of the beer. As can be appreciated by one of ordinary skill in the art, the size of the filter(s) may be selected based on a number of factors (e.g., desired clarity, processing time, flow rate, taste considerations, amount of complex formation, etc.) and, as such, the size of the filter may be set to be larger or smaller than described herein.

The method 100 proceeds by transferring the beer spirit to kegs, or other containers, to allow for bottling (step 132). In one embodiment, the kegs may be constructed from stainless steel with no lining. It should be appreciated that the present method 100 is not limited to the use of such kegs, and any keg or container that allows bottling without imparting a negative flavor or chemical into the beer spirit may be used.

The method 100 may include adding one or more flavor extracts to the beer spirit (step 136). In one embodiment, orange, lemon grass, and/or other flavors may be added to the beer spirit to reach a final taste and aroma profile. As can be appreciated, the flavor additions may take the form of natural flavor extracts, plants, and/or other additives that contribute to the final profile. These flavor additions may include, but are in no way limited to, orange, currant, raisin, cherry, cinnamon, nutmeg, brown sugar, brandy, and lemon to name a few. In some embodiments, botanicals may be used to flavor the beer spirit. The botanicals may be in a leaf, flower, pellet, and/or powder form and/or may be a botanical extract (e.g., from a flavor house, etc.). In some embodiments, the botanicals may be steeped in the beer during the aging step (e.g., step 116) to impart flavor. Steeping the botanicals in the beer during the aging step may require additional steps for handling solids in the beer spirit and/or subsequent filtering of the beer spirit. In any of the embodiments described herein, the taste of the beer spirit may be flavored to mimic the taste and/or flavor of a rich fruit cake.

In some embodiments, the method 100 may include a step of performing a final ABV correction, or adjustment, step. This ABV adjustment step may follow the aging step 116, or any other step after the aging step 116, in the method 100 for processing beer into spirits. In one embodiment, the ABV adjustment step may follow the steps of cooling, filtration, and even flavor addition. For instance, once the beer spirit has been formed and flavored, the final ABV adjustment may be made by adding water (e.g., to reduce the final ABV of the beer spirit) or by adding a spirit (e.g., a neutral grain spirit, or any other spirit, to increase the final ABV of the beer spirit). In one example, where the beer spirit has a 21% ABV after it has been formed, the water may be added to the beer spirit to adjust the beer to approximately 20% ABV or some other desired, final ABV, value lower than 21% ABV. In another example, where the beer spirit has a 20% ABV, or lower, after it has been formed, a spirit (e.g., a neutral grain spirit, or other spirit, etc.) may be added to the beer spirit to adjust the beer to approximately 21% ABV or some other desired final ABV value higher than 20% ABV (e.g., 22% ABV or higher, etc.). Among other things, this processing step may provide some leeway in production (e.g., if any water was picked up during processing or if alcohol was lost from the beer spirit when aged at the elevated temperature, etc.) allowing the final ABV to be adjusted and/or set by the addition of water (e.g., to reduce the ABV from a first value to a lower second value) or by the addition of a spirit (e.g., to increase the ABV from a first value to a higher second value). In one embodiment, the process may be tailored to begin with a higher ABV beer and perform the adjustment step to lower the ABV to a desired post-processing ABV value. Alternatively, the process may be tailored to begin with a lower, but still high-gravity, ABV beer and perform the adjustment step to increase the ABV to a desired post-processing ABV value. In any event, the final, post-processing, ABV value of the beer spirit may be set to qualify as a “made-wine” under current or future definitions of the same (e.g., as defined by the HMRC, etc.). For example, made-wine may comprise any drink that has alcohol made by fermentation apart from cider, not by distillation or any other process. In some embodiments, the beer described herein may be classed as made-wine when mixed with other products (e.g., spirits, etc.) and having an ABV greater than 5.5%.

Although described as producing a beer spirit having a final ABV of 20% from a supplied beer having an initial ABV of 21%, 24%, or higher, it should be appreciated that alternative ABV values may be used in the various steps of the method 100 described above. For instance, the method 100 may age beer having an ABV of 18% to produce a beer spirit having an ABV of 18% or lower. Additionally or alternatively, the method 100 may age beer having an ABV of 24% (or more) to produce a beer spirit having an ABV of less than 24% (e.g., 18%, 20%, etc., and/or any other ABV value lower than 24%). In one embodiment, the method 100 may age beer having an ABV of 24% (or more) to produce a beer spirit having an ABV of 24% (or more). It is an aspect of the present disclosure that the ABV values may be set, selected, and/or adjusted, to prevent fire hazards during production and to produce a desired final ABV value for the beer spirit using the method 100 as described herein.

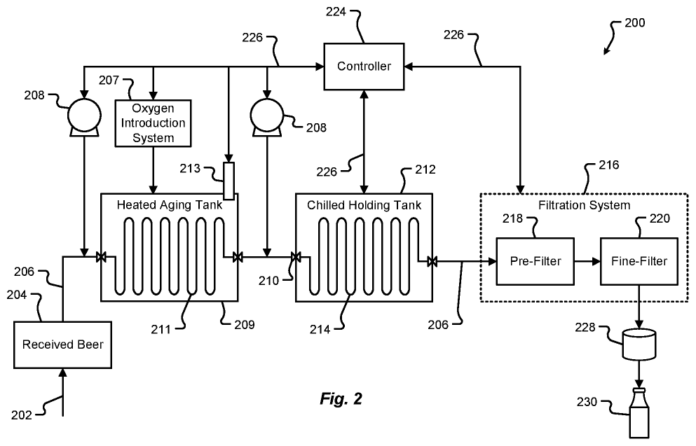

FIG. 2 shows a block diagram of a beer spirit processing system 200 in accordance with embodiments of the present disclosure. The beer spirit processing system 200 may produce a spirit from beer in accordance with embodiments of the method 100 described above. In some embodiments, the beer spirit processing system 200 may include a heated aging tank 209, a chilled holding tank 212, and a filtration system 216. In some embodiments, the beer and/or beer spirt may be conveyed alone one or more fluid lines 206. The fluid lines 206 may comprise one or more pipes, tubes, hoses, gates, valves, and/or the like. In one embodiment, the fluid lines 206 may be pressurized to pump and/or otherwise convey beer and/or beer spirit fluid through the beer spirit processing system 200.

The beer may be provided via an infeed stream 202. The infeed stream 202 may correspond to the exit stream of an alcohol concentration system, such as RO, an FO, and/or a combination RO/FO system. In one embodiment, the beer provided via the infeed stream 202 may correspond to a beer having an ABV between, and including, 24% to 54% ABV, or more. In some embodiments, the beer may have an ABV greater than 5%.

The beer may be conveyed to the heated aging tank 209 along one or more fluid lines 206 (e.g., from the infeed stream 202, an IBC 204, and/or beer tank, etc.). In some embodiments, the beer may be pumped from the IBC 204 to the heated aging tank 209 via at least one pump 208. While in the heated aging tank 209, the beer may be heated via one or more heating elements 211 to the elevated temperature of 45° C. to 50° C. In some embodiments, the temperature range of the elevated temperature may be maintained by the controller 224 in conjunction with one or more thermocouples, or the like, disposed in or adjacent to the heated aging tank 209. As described in conjunction with step 116 of the method 100 above, the beer may be held in the heated aging tank 209 for an aging period of 7 days to 21 days, or more.

An oxygen introduction system 207 may be interconnected to the heated aging tank 209 and the controller 224. The oxygen introduction system 207 may correspond to one or more of an aeration system, injection system, infusion system, mixing system, and/or other oxygen introduction machine that introduces oxygen into the beer, as described above. In one embodiment, the oxygen introduction system 207 may comprise a portion of the heated aging tank 209 that is designed with a large head space and an oxygen rich atmosphere (e.g., providing an oxygen exposure zone) to introduce oxygen into the beer. In any event, the introduction of oxygen increases dissolved oxygen concentrations in the beer and induces oxidation of the beer while it is aging over time in the heated aging tank 209. This introduction of oxygen may be continuous or periodic during the aging time period.

In some embodiments, the introduction of oxygen into the beer may be controlled via the controller 224 to maintain the beer within an acceptable oxygen concentration range (e.g., below saturation). Control of the dissolved oxygen concentrations may include measuring the dissolved oxygen concentration levels, for example, via a dissolved oxygen sensor 213 that is in contact with the beer in the heated aging tank 209. The dissolved oxygen sensor 213 may be at least partially submerged in the beer in the tank and may be configured to continuously measure the dissolved oxygen concentration levels in the beer. The dissolved oxygen sensor 213 may communicate with the controller 224, in real time or near real time, via at least one bus 226. In response to receiving the dissolved oxygen concentration measurement from the dissolved oxygen sensor 213, the controller 224 may adjust the rate at which oxygen is introduced into the beer by the oxygen introduction system 207. Stated another way, if the measurement of dissolved oxygen concentration raises above a threshold value, the controller 224 may decrease a flow rate of the oxygen introduction system 207 (e.g., and a corresponding reduction in the oxygen introduced into the beer, etc.). Additionally or alternatively, if the measurement of dissolved oxygen concentration falls below a threshold value, the controller 224 may increase a flow rate of the oxygen introduction system 207 (e.g., and a corresponding increase in the oxygen introduced into the beer, etc.). In some embodiments, for example, where the measured dissolved oxygen concentration is above and outside of an acceptable concentration range) the controller 224 may cease any introduction of oxygen into the beer via the oxygen introduction system 207 (e.g., turning off the oxygen introduction system 207, closing a valve between the oxygen introduction system 207 and the heated aging tank 209, and/or deactivating a pump of the oxygen introduction system 207, etc.). The flow rate of the oxygen introduction system 207 may be controlled by the controller 224 periodically or continuously while the beer is aging in the heated aging tank 209. As provided above, the beer may be maintained and/or controlled to have dissolved oxygen concentrations in the range of 300 ppb to 2,000 ppb in a specific volume of beer.

Once aged and oxidized, the beer may transform into a beer spirit. The beer spirit may be allowed to cool to room temperature in the heated aging tank 209, in the fluid lines 206, in an intermediate tank disposed between the heated aging tank 209 and the chilled holding tank 212, and/or in the chilled holding tank 212.

The cooled beer spirt may then be conveyed to the chilled holding tank 212 along one or more fluid lines 206. The chilled holding tank 212, as described above, may comprise a tank or fluid line that is temperature controlled by a chiller 214. The chiller 214 may comprise a glycol, or other, cooled system having one or more coolant lines that wrap around a portion of the chilled holding tank 212. In one embodiment, the chiller 214 may comprise a plate and frame heat exchanger. For instance, the beer spirit may flow on one side of the heat exchanger, while a coolant (e.g., glycol, etc.) may flow on the other side of the heat exchanger thereby cooling the beer spirit. In some embodiments, the fluid lines 206, the inlet, and/or the outlet of chilled holding tank 212 may be flow controlled by one or more valves 210 (e.g., solenoid valves, gate valves, butterfly valves, needle valves, combinations thereof, and/or the like). Actuation of the valves 210 may be controlled by the controller 224 (e.g., sending a control signal across bus 226). The bus 226 may correspond to a communications, power, and/or combination bus. Additionally or alternatively, the controller 224 may control a temperature and set point of the chiller 214. In some embodiments, the controller 224 may correspond to a proportional-integral-derivative (PID) controller, that continually monitors a temperature of the chilled holding tank 212 (e.g., via one or more temperature probes, thermocouples, etc.) and adjusts the cooling provided via the chiller 214. In some embodiments, the chiller 214 may be set to maintain the chilled holding tank 212, and the beer spirit therein, at a temperature range of, and including, −2° C. to −6° C.

The beer spirit may be held in the chilled holding tank 212 for a predetermined amount of time (e.g., the chill period) to allow the beer spirit to reach a predetermined temperature (e.g., the chill temperature) in a temperature range (e.g., −2° C. to −6° C., etc.). For example, the beer spirit may be held in the chilled holding tank 212 for a time period between, and including, seven days to twenty-one days. As can be appreciated, these times may be varied depending on the ambient temperature surrounding the chilled holding tank 212, the rate of precipitation of polyphenol/protein complexes from the beer spirit, and/or the like. In some embodiments, the holding times may be decreased when polyphenol/protein complexes have completely, or substantially completely, precipitated. Additionally or alternatively, the holding times may be increased when the precipitation of the polyphenol/protein complexes is observed to be incomplete.

Once sufficiently cooled, the reduced temperature beer spirit may be passed onto the filtration system 216. In one embodiment, the beer spirit may be pumped through one or more fluid lines 206 via a pump 208. The filtration system 216 may include a series of filters 218, 220 arranged to progressively filter solids, ingredients, and/or other compounds from the beer spirit. The filters 218, 220 may include a pre-filter 218 having a first size of filter media and a fine-filter 220 having a second size of filter media. In some embodiments, the first size of filter media may be coarser than the second size of filter media. For instance, the pre-filter 218 may include one or more cellulose and/or polypropylene membranes having a 1.0 to 5.0 micron filtration size. The fine-filter 120 may include a ceramic and/or polysulfone membrane, a polypropylene filter, and/or a diatomaceous earth depth filter. The fine-filter 120 may have a filtration size set smaller, or finer, than the pre-filter 118 (e.g., set to 0.25 micron to 1.0 micron, 0.5 micron, etc.). In some embodiments, the beer spirit may be pumped through the filters 218, 220 and into a storage tank 228, where the beer spirit is held prior to bottling 130.

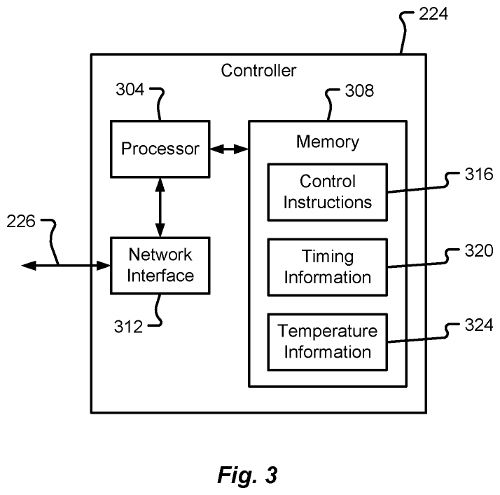

FIG. 3 shows a block diagram depicting an illustrative controller 224 in accordance with embodiments of the present disclosure. The controller 224 may be a part of the heated aging tank 209, the chilled holding tank 212, the filtration system 216, and/or any other component in the beer spirit processing system 200. In some embodiments, the controller 224 may be separate and apart from the components of the beer spirit processing system 200. In one embodiment, the controller 224 may comprise at least one of a programmable logic controller (PLC), synchronous link controller (SLC), industrial computer system, computer, mobile device, smartphone, combinations thereof, and/or the like. In any event, the controller 224 may include a processor 304, a memory 308, and a network interface 312.

The processor 304 may correspond to one or many computer processing devices. For instance, the processor 304 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 304 may be provided as a microprocessor, Central Processing Unit (CPU), or plurality of microprocessors that are configured to execute the instructions sets 316 stored in memory 308. Upon executing the instructions stored in memory 308, the processor 304 enables various device and system control in the beer spirit processing system 200 including, but in no way limited to, temperature control, heating element control, chiller control, pump control, valve actuation (e.g., opening and closing, etc.), timers, PID control, etc., and/or combinations thereof.

The memory 308 may include any type of computer memory device or collection of computer memory devices. Non-limiting examples of the memory 308 may include Random Access Memory (RAM), Read Only Memory (ROM), flash memory, Electronically-Erasable Programmable ROM (EEPROM), Dynamic RAM (DRAM), etc. The memory 308 may be configured to store the instructions 316 depicted in FIG. 3 in addition to temporarily storing data for the processor 304 to execute various types of routines or functions. Although not depicted, the memory 308 may include instructions that enable the processor 304 to store and/or retrieve data in an automation or system control database.

The instruction sets stored in the memory 308 may include, but are in no way limited to, control instructions 316, temperature control instructions, timing control instructions, processing instructions (e.g., according to the method 100 described above, etc.). Functions of the controller 224 enabled by these various instruction sets will be described in further detail herein. It should be appreciated that the instructions 316 depicted in FIG. 3 may be combined (partially or completely) with other instruction sets or may be further separated into additional and different instruction sets, depending upon configuration preferences for the controller 224. In any event, the particular instructions 316 depicted in FIG. 3 should not be construed as limiting embodiments described herein.

The control instruction set 316, when executed by the processor 304, may enable the controller 224 to manage one or more operations of the pump 208, valves 210, heated aging tank 209, chilled holding tank 212, and/or the filtration system 216. The control instructions 316 may send signals (e.g., including commands, voltage, etc.) across the bus 226 via the network interface 312. In some embodiments, the control instructions 316 may control movement of the beer and/or beer spirit through the beer spirit processing system 200 by actuating valves 210, activating pumps 208, and/or other portions of the system 200. Additionally or alternatively, the control instructions 316 may refer to timing information 320 to set timers (e.g., incrementing or decrementing) for maintaining the beer in the heated aging tank 209 and/or the beer spirit in the chilled holding tank 212. In one example, upon an expiration of the set timer, the controller 224 may send instructions to move the beer into the heated aging tank 209, beer spirit from the heated aging tank 209 to the chilled holding tank 212, and/or beer spirit from the chilled holding tank 212 to the filtration system 216. In some embodiments, the control instructions 316 may refer to temperature information 324 to set, adjust, and/or maintain a temperature, or temperature range, of the heating element 211 and/or the chiller 214.

As provided above, the network interface 312 may provide the controller 224 with the ability to send and receive communication packets, power signals, and/or the like over the bus 226. The network interface 312 may be provided as a network interface card (NIC), a network port, drivers for the same, and the like. Communications between the components of the controller 224 and other devices in the beer spirit processing system 200 may all flow through the network interface 312 of the controller 224.

Any of the steps, functions, and operations discussed herein can be performed continuously and automatically.

The exemplary systems and methods of this disclosure have been described in relation to beer and spirits, and in particular to spirits produced from high gravity, very-high gravity, and/or ultra-high gravity beer, and efficient processes for making the same. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

While the flowcharts have been discussed and illustrated in relation to a particular sequence of events, it should be appreciated that changes, additions, and omissions to this sequence can occur without materially affecting the operation of the disclosed embodiments, configuration, and aspects. For example, although the oxidation is described above as being induced while the beer is aged for a predetermined time period, it should be appreciated that oxygen may be introduced into the beer at any stage of the process prior to chilling and filtration to encourage oxidation.

A number of variations and modifications of the disclosure can be used. It would be possible to provide for some features of the disclosure without providing others.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a method for converting beer into spirits, comprising: introducing a beer into an aging tank; heating the beer inside the aging tank to a controlled temperature, wherein the controlled temperature is in a range of 45° C. to 50° C.; maintaining the controlled temperature of the beer inside the aging tank for an aging period, introducing oxygen into the beer while inside the aging tank, wherein during the aging period the beer transforms into a spirit; holding the spirit at a chill temperature in a range of −2° C. to −6° C. for a chill period; and pumping the spirit through a filtration system.

Aspects of the above method include wherein the beer is between 20% and 24% alcohol by volume. Aspects of the above method include wherein prior to introducing the beer into the aging tank, the method further comprises: receiving an ultra-high gravity beer between 24% and 54% alcohol by volume; and diluting the ultra-high gravity beer to the beer at 21% alcohol by volume by adding a deaerated liquid to the ultra-high gravity beer. Aspects of the above method include wherein the aging period is between 7 days and 21 days. Aspects of the above method include wherein after the aging period, the method further comprises: conveying, via at least one fluid line, the spirit from the aging tank to a chilled holding tank, wherein the spirit is held at the chill temperature inside the chilled holding tank. Aspects of the above method include wherein the chill period is between 24 hours and 72 hours. Aspects of the above method include wherein prior to holding the spirit inside the chilled holding tank, the method comprises: cooling the spirit from the controlled temperature to room temperature in a range between 20° C. and 25° C. Aspects of the above method include wherein introducing oxygen comprises pumping the oxygen into the beer such that dissolved oxygen concentrations in the beer are in a range of 300 ppb to 2,000 ppb. Aspects of the above method include wherein the filtration system includes a filter having a filtration media set to 1.0 micron. Aspects of the above method include wherein botanicals are added to the beer inside the aging tank, and wherein the botanicals are allowed to steep in the beer at the controlled temperature for the aging period. Aspects of the above method further comprise: adding flavor ingredients to the spirit after the spirit is pumped through the filtration system. Aspects of the above method further comprise: bottling the spirit including the flavor ingredients added. Aspects of the above method include wherein during the aging period, an oxidation of polyphenols results in a complexation of the polyphenols with proteins into solids, the removal of which, via filtration, results in colloidal stability of the spirit. Aspects of the above method include wherein during the aging period, at least one of Strecker aldehydes, Maillard compounds, furanones, and other flavor compounds are formed in the beer.

Embodiments include a system for transforming beer into spirits, comprising: a feed stream providing a beer having an alcohol by volume in a range of 20% to 54%; a heated tank set at an elevated temperature within a range of 45° C. to 50° C., wherein the heated tank holds the beer at the elevated temperature received from the feed stream for a predetermined aging time period; an oxygen introduction system that introduces oxygen into the beer while held inside the heated tank, wherein the oxygen is introduced into the beer such that the beer comprises a dissolved oxygen concentration in a range of 300 ppb to 2,000 ppb, and wherein during the predetermined aging time period the beer transforms into a spirit; a chilled tank set at a temperature within a range of −2° C. to −6° C., wherein the chilled tank holds the spirit received from the heated tank for a predetermined chill time period; a filtration system comprising a series of filter elements arranged in a fluid flow path; a pump that conveys the spirit from the chilled tank after expiration of the predetermined chill time period through the filtration system via the fluid flow path; and a collection tank that stores the spirit pumped through the filtration system.

Aspects of the above system include wherein the predetermined aging time period is between 7 days and 21 days. Aspects of the above system include wherein the predetermined chill time period is between 24 hours and 72 hours. Aspects of the above system include wherein during the predetermined aging time period, an oxidation of polyphenols drives a complexation with proteins to drive colloidal stability from the beer. Aspects of the above system include wherein during the predetermined aging time period, Strecker aldehydes and other oxygen generated flavor compounds are generated from the beer.

Embodiments include a method, comprising: receiving a beer having an alcohol by volume of at least 24%; decanting the beer into an intermediate bulk container; diluting the beer to an alcohol by volume of 21% using a deaerated liquid; aging the diluted beer in a holding tank at a temperature of 45° C. to 50° C. for an aging period between 7 and 21 days; introducing oxygen into the beer while in the holding tank, wherein the oxygen is introduced into the beer such that the beer comprises a dissolved oxygen concentration in a range of 300 ppb to 2,000 ppb, and wherein the introduction of the oxygen and the aging together transforms the beer into a spirit; cooling the spirit to a temperature below 45° C.; chilling the spirit to a subzero temperature of −2° C. to −6° C. for a chill period between 24 and 72 hours; filtering the chilled spirit through a filter media having a filtration size between 0.5 and 5 microns; conveying the filtered spirit to a storage container; and adding flavor extracts to the filtered spirit.

Aspects of the above method include wherein, after adding the flavor extracts to the filtered spirit, the method further comprises: adjusting a final alcohol by volume of the filtered spirit to 20%, or lower, by adding water to the filtered spirit. Aspects of the above method include wherein, after adding the flavor extracts to the filtered spirit, the method further comprises: adjusting a final alcohol by volume of the filtered spirit to 22%, or higher, by adding a neutral grain spirit to the filtered spirit.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A method for converting beer into spirits, comprising:
introducing a beer into an aging tank;
heating the beer inside the aging tank to a controlled temperature, wherein the controlled temperature is in a range of 45° C. to 50° C.;
maintaining the controlled temperature of the beer inside the aging tank for an aging period,
introducing oxygen into the beer while inside the aging tank, wherein during the aging period the beer transforms into a spirit;
holding the spirit at a chill temperature in a range of −2° C. to −6° C. for a chill period; and
pumping the spirit through a filtration system.

2. The method of claim 1, wherein the beer is between 20% and 24% alcohol by volume.

3. The method of claim 1, wherein prior to introducing the beer into the aging tank, the method further comprises:
receiving an ultra-high gravity beer between 24% and 54% alcohol by volume; and
diluting the ultra-high gravity beer to the beer at 21% alcohol by volume by adding a deaerated liquid to the ultra-high gravity beer.

4. The method of claim 3, wherein the aging period is between 7 days and 21 days.

5. The method of claim 4, wherein after the aging period, the method further comprises:
conveying, via at least one fluid line, the spirit from the aging tank to a chilled holding tank, wherein the spirit is held at the chill temperature inside the chilled holding tank.

6. The method of claim 5, wherein the chill period is between 24 hours and 72 hours.

7. The method of claim 6, wherein prior to holding the spirit inside the chilled holding tank, the method comprises:
cooling the spirit from the controlled temperature to room temperature in a range between 20° C. and 25° C.

8. The method of claim 6, wherein introducing oxygen comprises pumping the oxygen into the beer such that dissolved oxygen concentrations in the beer are in a range of 300 ppb to 2,000 ppb.

9. The method of claim 6, wherein the filtration system includes a filter having a filtration media set to 1.0 micron.

10. The method of claim 6, wherein botanicals are added to the beer inside the aging tank, and wherein the botanicals are allowed to steep in the beer at the controlled temperature for the aging period.

11. The method of claim 6, further comprising:
adding flavor ingredients to the spirit after the spirit is pumped through the filtration system; and
bottling the spirit including the flavor ingredients added.

12. The method of claim 11, wherein during the aging period, an oxidation of polyphenols results in a complexation of the polyphenols with proteins into solids, the removal of which, via filtration, results in colloidal stability of the spirit.

13. The method of claim 12, wherein during the aging period, at least one of Strecker aldehydes, Maillard compounds, furanones, and other flavor compounds are formed in the beer.

14. A system for transforming beer into spirits, comprising:
a feed stream providing a beer having an alcohol by volume in a range of 20% to 54%;
a heated tank set at an elevated temperature within a range of 45° C. to 50° C., wherein the heated tank holds the beer at the elevated temperature received from the feed stream for a predetermined aging time period;
an oxygen introduction system that introduces oxygen into the beer while held inside the heated tank, wherein the oxygen is introduced into the beer such that the beer comprises a dissolved oxygen concentration in a range of 300 ppb to 2,000 ppb, and wherein during the predetermined aging time period the beer transforms into a spirit;
a chilled tank set at a temperature within a range of −2° C. to −6° C., wherein the chilled tank holds the spirit received from the heated tank for a predetermined chill time period;
a filtration system comprising a series of filter elements arranged in a fluid flow path;
a pump that conveys the spirit from the chilled tank after expiration of the predetermined chill time period through the filtration system via the fluid flow path; and
a collection tank that stores the spirit pumped through the filtration system.

15. The system of claim 14, wherein the predetermined aging time period is between 7 days and 21 days, and wherein the predetermined chill time period is between 24 hours and 72 hours.

16. The system of claim 15, wherein during the predetermined aging time period, an oxidation of polyphenols drives a complexation with proteins to drive colloidal stability from the beer.

17. The system of claim 15, wherein during the predetermined aging time period, Strecker aldehydes and other oxygen generated flavor compounds are generated from the beer.

18. A method, comprising:
receiving a beer having an alcohol by volume of at least 24%;
decanting the beer into an intermediate bulk container;
diluting the beer to an alcohol by volume of 21% using a deaerated liquid;
aging the diluted beer in a holding tank at a temperature of 45° C. to 50° C. for an aging period between 7 and 21 days;
introducing oxygen into the beer while in the holding tank, wherein the oxygen is introduced into the beer such that the beer comprises a dissolved oxygen concentration in a range of 300 ppb to 2,000 ppb, and wherein the introduction of the oxygen and the aging together transforms the beer into a spirit;
cooling the spirit to a temperature below 45° C.;
chilling the spirit to a subzero temperature of −2° C. to −6° C. for a chill period between 24 and 72 hours;
filtering the chilled spirit through a filter media having a filtration size between 0.5 and 5 microns;
conveying the filtered spirit to a storage container; and
adding flavor extracts to the filtered spirit.

19. The method of claim 18, wherein, after adding the flavor extracts to the filtered spirit, the method further comprises:
adjusting a final alcohol by volume of the filtered spirit to 20%, or lower, by adding water to the filtered spirit.

20. The method of claim 18, wherein, after adding the flavor extracts to the filtered spirit, the method further comprises:
adjusting a final alcohol by volume of the filtered spirit to 22%, or higher, by adding a neutral grain spirit to the filtered spirit.
